(19) United States
(12) Patent Application Publication
(10) Pub. No.: US 2010/0089424 A1
(43) Pub. Date: Apr. 15, 2010

(54) PLANT AND METHOD FOR WASHING CONTAINERS OF FOODS AND/OR MEDICAL AND PHARMACEUTICAL PRODUCTS

(75) Inventor: Giovanni Battista Colussi, Casarsa Della Delizia (IT)

Correspondence Address: HAMRE, SCHUMANN, MUELLER & LARSON, P.C., P.O. BOX 2902, MINNEAPOLIS, MN, 55402-0902, US

(73) Assignee: COLUSSI ERMES SRL, Casarsa Della Delizia (PN) (IT)

(21) Appl. No.: 12/530,878

(22) PCT Filed: Mar. 12, 2008
(86) PCT No.: PCT/IB2008/000577

§ 371 Date: Sep. 11, 2009

(30) Foreign Application Priority Data
Mar. 14, 2007 (IT) UD2007A000054

(51) Int. Cl. B08B 9/00

(52) U.S. Cl. 134/23; 134/166 R

(57) ABSTRACT

A plant and method for washing containers comprising a base wall and a plurality of lateral sides hinged to the base wall in order to define at least a first folded condition, in which the sides are folded in overlapping pairs and substantially parallel to the base wall, and a second open condition, in which the sides are substantially perpendicular to the base wall and define a containing compartment of the container. The plant comprises a washer machine into which the containers are fed in the first folded condition, and provided inside with a plurality of delivery nozzles. At least part of the delivery nozzles are disposed and directed with respect to the containers in such a manner as to direct the washing liquid delivered under pressure mainly towards a first external lateral side, so as to determine the at least partial opening of a second external lateral side with respect to the base wall.

### FIELD OF THE INVENTION

The present invention concerns a plant, and relative method, for washing containers of foods, such as boxes for containing fruit, vegetables, meats or other, and/or containers for medical and pharmaceutical products, made of rigid material and selectively configured in a first folded and flattened condition of non-use and in a second open condition of containment.

### BACKGROUND OF THE INVENTION

Containers are known, such as boxes or others, usable for the transport and storage of food goods, like fruit, vegetables, meats or other, and/or medical and pharmaceutical products, like medicines, medications, operating instruments or other.

Known containers usually consist of a base wall of rectangular, or square, shape and four lateral containing sides that extend upwards perpendicularly from the base wall, to define a containing compartment for the objects contained. At least two opposite sides of the four have through apertures which function as a gripping handle to transport the container.

Containers of variable configuration are also known, in which the lateral sides are generally hinged along the edges of the base wall so that they can be selectively rotated with respect to the latter and thus define a first folded condition, in which the sides are disposed two by two substantially parallel to the base and define a minimum and flattened bulk of the container, and a second open condition, in which the sides are substantially perpendicular to the base and define the containing compartment of the container.

In the first closed condition, the two sides with the through apertures are folded more externally with respect to the other two sides, and have the relative edges adjacent, very close together, or partly overlapping so as to define substantially a single surface.

In the second open condition the sides are advantageously consolidated one to the other by means of reciprocal attachment devices such as clips, snap-in joints or others, in any case attachable or detachable by pressure.

Plants are also known for washing, cleaning and, possibly, sterilizing said variable configuration containers, plants that substantially comprise in line:
a mechanical unit for opening the containers, which provides, by means of specific automated or semiautomatic mechanical members, for the prior opening of the sides of the container;
a washer machine, into which the container in its open condition is fed, and provided with a plurality of nozzles able to deliver a washing liquid, generally water, to wash at least the surfaces of the containing compartment;
and a mechanical unit for closing the containers, which provides, by means of automated or semiautomatic mechanical members, to reconfigure the container in folded condition.

One of the main disadvantages of this type of known washing plants is the costs and times of management and maintenance of the specific mechanical members of the mechanical opening. unit. Indeed, these mechanical members are very complex since they have to be configured to rotate the sides one by one, or two by two, with respect to the base, positioning them reciprocally with a certain accuracy, in such a manner as to guarantee the correct configuration in the open condition of the containers, before washing.

Furthermore, the mechanical opening unit initially entails a waiting down-time for the washer machine, caused precisely by the need to open the containers before they are washed. This disadvantage therefore entails a reduction of productivity of the washer machine.

Furthermore, in known washing plants, the feed of the containers through the washer machine occurs by means of a conveyor belt that supports the containers holding them from the sides, with the containing compartment open downwards.

By doing so, however, it is necessary to reciprocally attach the sides to each other after opening, in order to guarantee the structural solidity of the container and to avoid accidental refolding of the containers during the washing steps.

This disadvantage, however, causes a further increase both in the complexity of the mechanical opening member, and also in the time necessary for the prior opening of the sides, and consequently, for their closing, which in fact has to comprise at least a step of reciprocal detachment of the sides.

Washing plants are also known, for example described in the German patent DE-C-4420559, which are alternatives to those with the mechanical opening members, in which the washing nozzles face in such a way that they at least partially open the sides with respect to the base wall, and also close the sides when washing is completed.

This type of known plant, in order to open the sides, provides to direct the jet of water delivered by the nozzles in correspondence with the joining edges of the two outermost sides, so as to induce the water to filter through the joining edge.

The purpose of the filtered water is to generate a thrust on both sides, so as to cause them to open, substantially simultaneously, from inside.

This type of known plant has not found a favorable industrial application, since the very limited, if not non-existent, space between the two joining edges of the sides does not allow a sufficient quantity of water to filter through the joining edge, and therefore it does not generate a sufficient thrust to correctly open the two sides from inside.

Purpose of the present invention is to achieve a plant, and perfect a method, for washing containers for foods and/or medical and pharmaceutical products which allows to reduce to the minimum, if not eliminate completely, the costs and times of managing the mechanical members for opening the containers, and which allows to increase the productivity of the washer machine, also reducing the times necessary for the opening and refolding of the sides of the container.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

A washing plant according to the present invention is applied for washing containers of foods and/or medical and pharmaceutical products, in which the containers comprise at least a base wall and a plurality of lateral sides hinged to the base wall in order to define at least a first folded condition, in which the sides are folded in overlapping pairs and substantially parallel to the base wall, with two lateral sides disposed externally and two lateral sides disposed internally and adjacent to the base wall, and a second open condition, in which the sides are substantially perpendicular to the base and define a containing compartment of the container.

At least a first of the two external lateral sides has at least a through aperture.

In accordance with the above purpose, the plant according to the invention comprises at least a washer machine into which said containers are able to be fed in said first folded condition, and provided inside with a plurality of nozzles for the delivery of a washing liquid under pressure against said containers.

According to a characteristic feature of the present invention, at least some of said delivery nozzles are directed with respect to said containers so as to direct the washing liquid delivered under pressure mainly towards the first external lateral side provided with the through aperture, in correspondence with said through aperture.

In this way, through the through aperture, a sufficient quantity of washing liquid passes to generate a thrust on the rear surface at least of the second of the two external lateral sides determining the at least partial opening of the latter with respect to the base wall, and thus effect the washing of the container in an open condition, at least partially.

With the present invention therefore, even if the two external sides, in the first folded condition, have their respective joining edges adjacent, close together, partly overlapping, or in any case reciprocally configured so as not to allow a sufficient passage of liquid, in any case at least one external lateral side is guaranteed to open, and from here the opening cycle of the other sides is started, and the cycle of washing the container.

Therefore, the opening of the container is performed efficiently, directly inside the washer machine, by means of the delivery of the washing liquid, and therefore substantially in the same step of washing the container.

In this way, the need to provide the mechanical unit for opening the containers upstream of the washer machine is substantially eliminated, with the subsequent advantages in terms of the reduction of the management and maintenance costs and times which that entails.

Furthermore, with the present invention no waiting time is necessary, since the container enters into the washer machine directly in the folded condition and is opened during the washing step. This advantage allows to increase the productivity of the washer machine, since it is possible to exploit to the full its operating potential.

According to a variant, the washer machine comprises holding means disposed at least in correspondence with the delivery zone of the washing liquid by the nozzles, and able to hold at least the first external lateral side in its first folded position, so that the thrust action of the washing liquid is concentrated exclusively on the second external lateral side.

The holding means is conformed so as to end its holding action on the first external lateral side when the second external lateral side is at least partly open.

According to a variant, the holding means comprises at least a first shaped tubular element, disposed along the direction of feed of the containers, so as to present a first segment disposed in correspondence with the first external side, in order to prevent the rotation thereof, and a second segment outside the bulk of the first external side, freeing the possible rotation thereof.

According to another variant, the holding means comprises at least a second tubular element able to keep at least the second external side in its second open position.

According to another variant, the plant according to the present invention comprises a command and control unit installed on board the washer machine, and able to selectively manage the delivery of the washing liquid by means of one or the other of said delivery nozzles, so as to define a determinate sequence of opening the sides with respect to the base wall. The command and control unit also allows to manage the specific pressure of delivery of each delivery nozzle, or predefined groups of delivery nozzles.

According to another variant, the washer machine also comprises inside a translation member, for example a chain, opposite to the delivery nozzles and provided with gripper means able to maintain the containers suspended and facing the delivery nozzles, clamping them by the lateral edge of their base wall. In this way, the lateral sides remain substantially free and, therefore, there is no need to attach them reciprocally in order to guarantee the solidity of the container.

This advantage allows to further reduce the times of opening and refolding of the container, since it is also possible to provide a partial opening of the sides, sufficient to guarantee the delivery of the washing liquid against the internal surfaces of the containing compartment.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic side view of a washing plant for containers of foods and/or medical and pharmaceutical products;

FIG. 2 is a schematic view from above, partially sectioned, of the washing plant in FIG. 1;

FIG. 3 is a schematic three-dimensional view of a first operating step of the plant in FIG. 1;

FIG. 4 is a schematic three-dimensional view of a second operating step of the plant in FIG. 1;

FIG. 5 is a schematic three-dimensional view of a third operating step of the plant in FIG. 1;

FIG. 6 is a schematic three-dimensional view of a fourth operating step of the plant in FIG. 1;

FIG. 7 is a schematic three-dimensional view of a fifth operating step of the plant in FIG. 1;

FIG. 8 is a three-dimensional view a variant of FIG. 3;

FIG. 9 is a three-dimensional view of a variant of FIG. 4;

FIG. 10 is a three-dimensional view of a variant of FIG. 6.

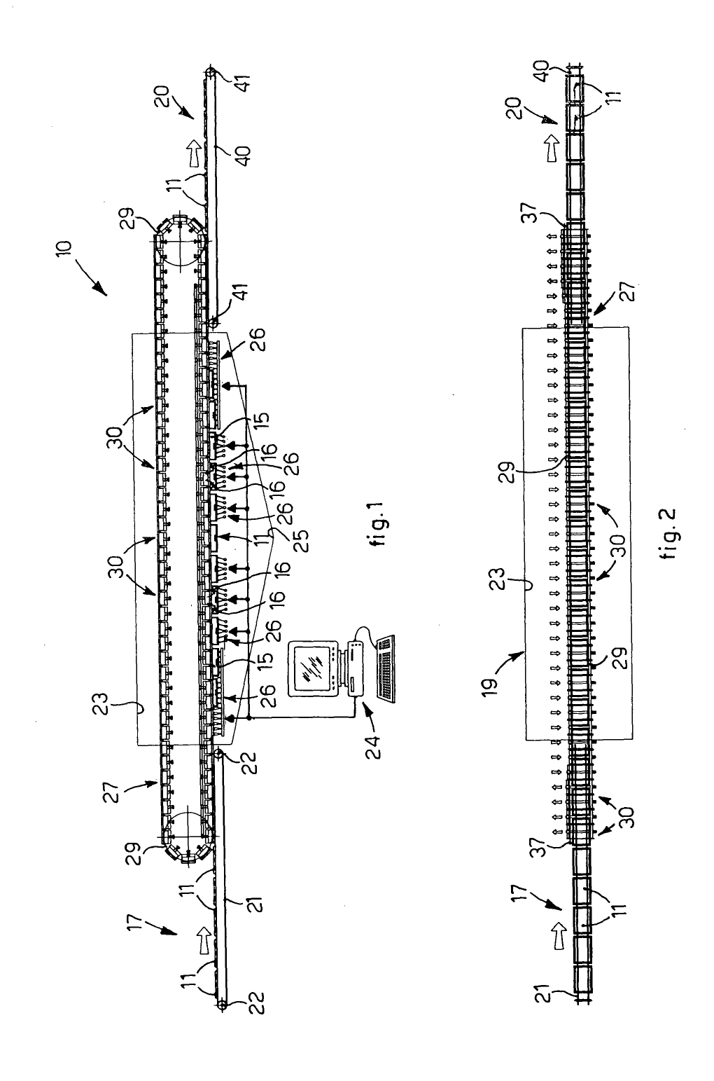

### DETAILED DESCRIPTION OF A PREFERENTIAL FORM OF EMBODIMENT

With reference to the attached drawings, a plant 10 according to the present invention is applied for washing boxes 11 used for the transportation and preservation of food, for example fruit, vegetables, meat or other, or for washing boxes 11 used for the transportation and preservation of medical and pharmaceutical products.

In particular each box 11 substantially consists, in a traditional way, of a base wall 13 of substantially rectangular shape, two long sides 15 hinged to two opposite edges of the base wall 13 and two short sides 16 hinged to the other two opposite edges of the base wall 13.

In particular, both the long sides 15 and the short sides 16 comprise a through aperture 18 which functions as a handle to lift and transport the box 11.

The box 11 is of the type with a variable configuration, that is, the two long sides 15 and the two short sides 16 can be selectively rotated two by two with respect to the base wall 13 to define a first folded condition of the box 11, in which they are substantially parallel to the base wall 13 and define a minimum bulk in height, and a second open condition of the box 11, in which they are substantially perpendicular to the base wall 13 and define a containing compartment 12.

In the first folded condition, the two long sides 15 are positioned more externally with respect to the two short sides 16, and are substantially adjacent to each other along a respective joining edge.

It is clear that the box 11 can have any shape and size, both standardized, for example 600×400×170, or 600×400×120, or 300×400×180, and personalized.

The plant 10 according to the present invention comprises, disposed in line with each other, a loading unit 17, a washer machine 19 and a discharge unit 20.

In particular, the loading unit 17 comprises a conveyor belt 21 disposed. annularly around two relative pulleys 22, of which one is motorized, and on which the boxes 11 to be washed are able to be placed, in their first folded condition.

In this case, the boxes 11 are positioned on the conveyor belt 21 with the respective long and short sides 15 and 16 facing downwards.

The washer machine 19 comprises a substantially closed washing chamber 23, inside which one or more washing tanks 25 are disposed, from each of which a plurality of groups of delivery nozzles 26 depart, able to delivery a washing liquid under pressure, for example water. In this specific case, only one washing tank 25 is provided, disposed in the lower part of the washing chamber 23 in such a manner that the groups of nozzles 26 deliver the water from below, upwards against the boxes 11.

According to the invention, at least the groups of delivery nozzles 26 that are in proximity with the entrance to the washing chamber 23 are disposed and directed in such a manner as to direct with certain angles the relative jets of water against the long and short sides 15 and 16 of the boxes 11.

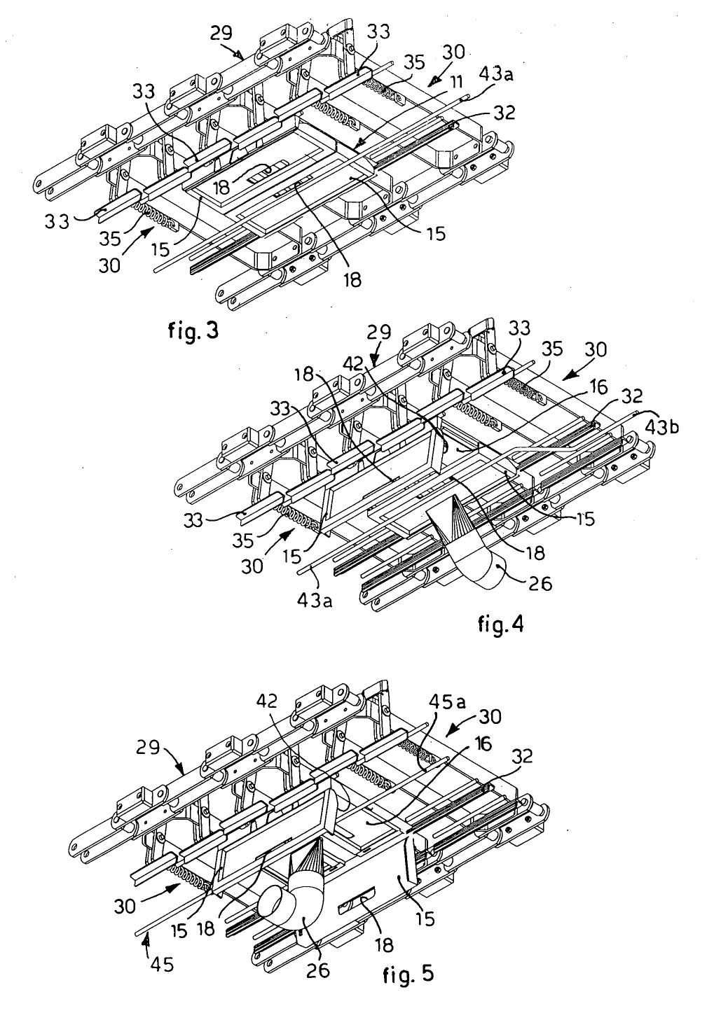

As shown in sequence in FIGS. 3 to 7, a first group of delivery nozzles 26 (FIG. 4) is directed and conformed to deliver a determinate jet of water mainly in correspondence with the through aperture 18 of a first of the long sides 15, so that the water delivered passes through the through aperture 18 and finds itself in contact with, and under pressure, the respective rear surfaces 42 of the long sides 15.

In this case, the washer machine 19 comprises a first holding bar 43 disposed below the boxes 11 and along their direction of feed.

In particular, the first holding bar 43 comprises a first segment 43a disposed in correspondence with the first group of nozzles 26, in cooperation with the first of the long sides 15, so as to prevent the rotation thereof with respect to the base wall 13.

In this way, the water that has passed through the through aperture 18 of the first long side 15 has an effective thrust action only on the rear surface 42 of the second of the two long sides 15, causing it to rotate with respect to the base wall 13, and therefore to open.

The first holding bar 43 also comprises a second segment 43b, continuous with the first segment 43a, and displaced laterally with respect to the first long side 15.

In correspondence with said second segment 43b, a second group of delivery nozzles 26 is provided (FIG. 5), which directs the jet of pressurized water at an angle, in the direction of the first of the long sides 15, causing it to rotate with respect to the base wall 13, and therefore to open.

The washer machine 19 also comprises a second holding bar 45, also disposed below the boxes 11, in their direction of feed.

The second holding bar 45 comprises a first segment 45a shaped so as to hold the second of the two long sides 15 in its open condition, preventing it from accidentally closing.

The second holding bar 45 also comprises a second segment 45b shaped so as to hold the first of the two long sides 15 in its open condition, preventing it from accidentally closing.

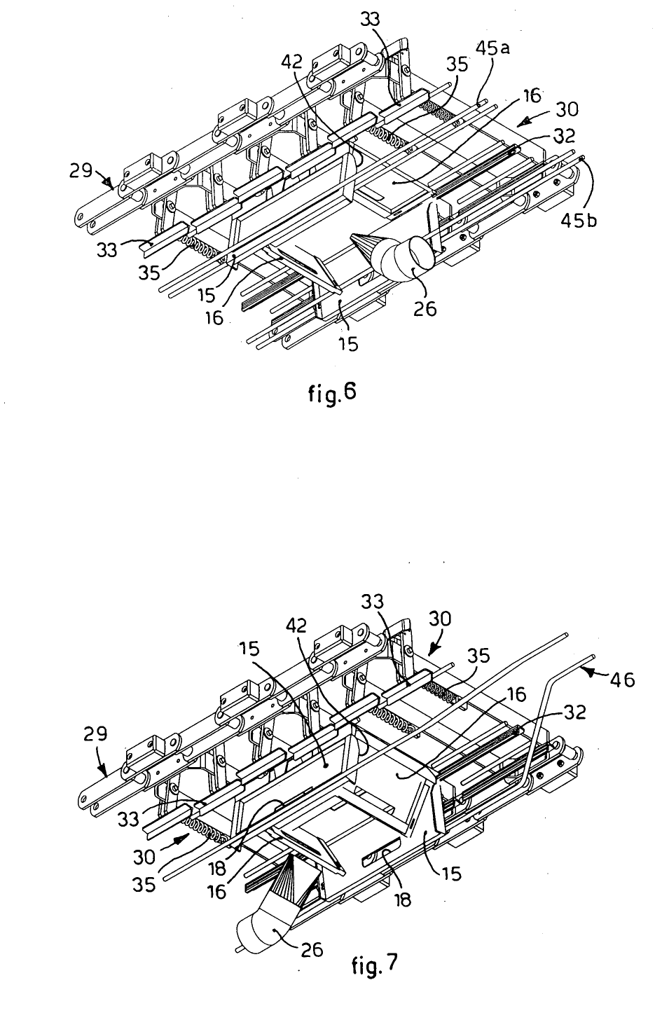

Subsequently, other groups of nozzles 26 are provided (FIGS. 6 and 7), which direct the relative jets of water in the direction of the second sides 16, to make them rotate with respect to the base wall 13, and therefore to open.

In this way the jets of water, upon impact, cause the respective sides 15 and 16 to rotate with respect to the base wall 13, determining the at least partial opening of the box 11 and, simultaneously, the washing of the internal surfaces of the containing compartment 12.

According to a variant, the nozzles 26 of each group are selectively rotatable around respective longitudinal and transverse axes, in order to define substantially a delivery arc.

In this way, the boxes 11 are opened and washed substantially at the same time.

In a manner opposite to that provided for opening the box 11, the sides 15 and 16 can be folded by the same jets of water delivered by the delivery nozzles 26. In this case, the delivery nozzles 26 provided in proximity with the exit of the washing chamber 23 are disposed and directed in such a manner as to determine a rotation to refold the long sides 15 and short sides 16, and to restore the folded condition of the boxes 11 after they have been washed and before they are discharged.

According to a variant, fixed or semi-mobile mechanical parts can be provided which, exploiting the advance of the boxes 11, cooperate with the sides 15 and 16 in order to effect, or facilitate, their refolding at the end of the wash, such as for example a third holding bar 46.

Advantageously, the plant 10 also comprises a programmed and programmable command and control unit 24, which is installed on board the washer machine 19 in order to manage the activation and/or pressure of the jet supplied by each delivery nozzle 26, so as to define a determinate sequence of opening, or closing, of the sides.

In this way it is possible, each time, to optimize the delivery of water and the opening of the long sides 15 and short sides 16, according to the design plan of the refolding of the latter with respect to the base wall 13.

The washer machine 19 also comprises a translation member 27 disposed in the upper part of the washing chamber 23, and able to automatically pick up the boxes 11 from the conveyor belt 21 in order to transport them, keeping them suspended, above the delivery nozzles 26, for the whole length of the washing chamber 23.

In this case, the translation member 27 consists of two chains 29 disposed substantially parallel one to the other and longitudinally to the washing chamber 23, and able to support and cyclically move a plurality of gripper devices 30 able, in turn, to clamp the boxes 11 from above, holding them along the edges of the respective base walls 13.

In this way, the boxes 11 are transported along the washing chamber 23 above the delivery nozzles 26, leaving complete freedom of rotation to the sides 15, 16, which are induced to open by the jets of water delivered by the delivery nozzles 26.

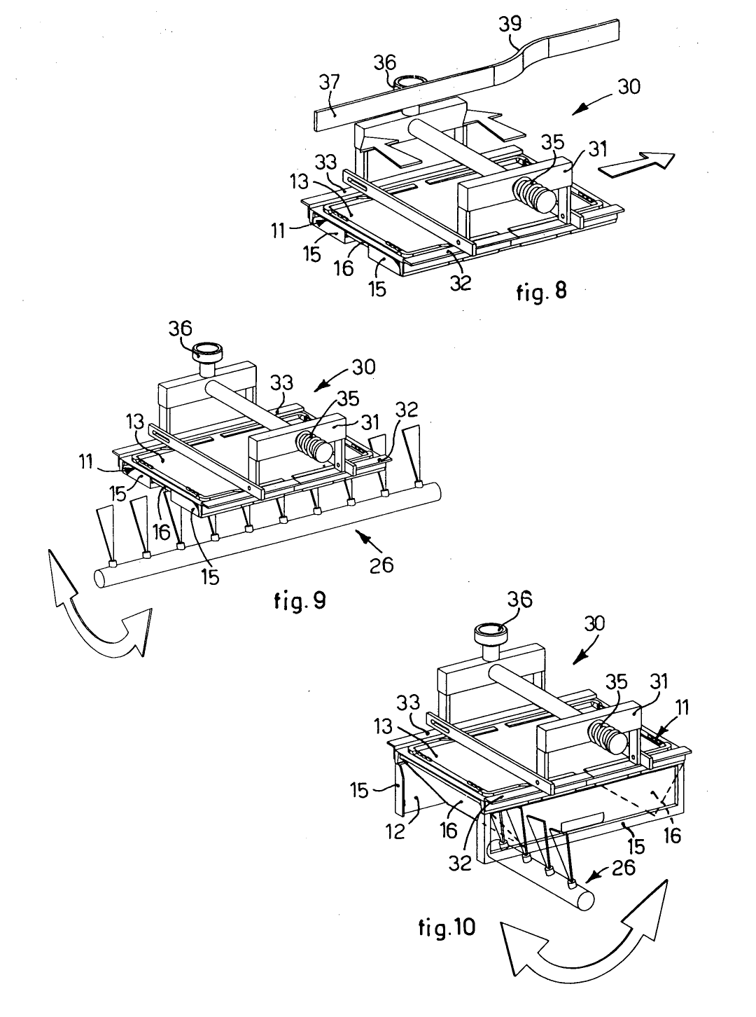

Each gripper device 30 comprises a frame 31 defining at least an abutment wall 32, and to which a mobile wall 33 is slidingly associated, on the side opposite to the abutment wall 32. Said mobile wall 33 is selectively moved between a first operating condition to clamp, and a second operating condition to release the box 11, by means of a runner or a roller (in the variant in FIGS. 8, 9 and 10) 36 that runs along a longitudinal shaped rail 37.

In particular, the longitudinal rail 37 has a guiding curve 39, respectively in proximity with the entrance end and exit end of the washing chamber 23, so as to serve as a guide cam for the runner or roller 36.

In fact, the sliding of the runner or roller 36 along the guiding curve 39 determines a transverse displacement of the runner or roller 36, entailing a displacement of the mobile wall 33 towards the operating condition of release.

Advantageously, the mobile wall 33 is associated with a thrust spring 35 mounted on the frame 31, which spring 35 normally exerts a pressure on the mobile wall 33 to maintain it in a clamping condition. The transverse movement of the roller 36 along the guiding curve 39 determines the compression of the thrust spring 35.

In the clamping condition, the gripper device 30 touches with its abutment wall 32 a first edge of the box 11 and with its mobile wall 33 a second edge of the box 11, opposite the first edge.

In particular, both the abutment wall 32 and the mobile wall 33 comprise respective knurled and/or indented surfaces, to increase the grip on the respective edges of the box 11, limiting to a minimum the risk of accidental sliding.

The discharge unit 20 comprises a conveyor belt 40 disposed annularly around two relative pulleys 41, of which one is motorized, and on which the already washed boxes 11 are able to be disposed, and returned to their first folded condition.

The functioning of the plant 10 for washing boxes 11 as described above is as follows.

The boxes 11 are loaded in their folded condition on the conveyor belt 21 with the long sides 15 and short sides 16 facing downwards.

The conveyor belt 21 transports the boxes 11 inside the washing chamber 23, where the gripper devices 30 of the translation member 27 clamp the boxes by the edges of the respective base walls 13, and transport them along the whole length of the washing chamber 23, until they position them on the conveyor belt 40 of the discharge unit 20.

As we said, during their movement through the washing chamber 23, the boxes 11 are subjected to the targeted jet of the groups of delivery nozzles 26 and the holding bars 43, 45 and 46, both to be opened and refolded, and also to be washed.

It is clear, however, that modifications and/or additions of parts or steps may be made to the plant 10 and method as described heretofore, without departing from the field and scope of the present invention.

It is also clear that, although the present invention has been described with reference to specific examples, a person of skill in the art shall certainly be able to achieve many other equivalent forms of plants and method for washing containers of foods and/or medical and pharmaceutical products, having the characteristics as set forth in the claims and hence all coming within the field of protection defined thereby.

1. A plant for washing containers of foods and/or medical and pharmaceutical products, in which said containers comprise at least a base wall and a plurality of lateral sides hinged to said base wall in order to define at least a first folded condition, in which said sides are folded in overlapping pairs and substantially parallel to said base wall, with two lateral sides disposed external and two lateral sides disposed internal and adjacent to the base wall, and a second open condition, in which said sides are substantially perpendicular to said base wall and define a containing compartment of said container, at least a first of said two external lateral sides having at least a through aperture, in which said plant comprises at least a washer machine into which said containers are able to be fed in said first folded condition, and provided inside with a plurality of delivery nozzles able to deliver a washing liquid under pressure against said containers, and in which at least part of said delivery nozzles are disposed and directed with respect to said containers in such a manner as to direct said washing liquid delivered under pressure mainly towards said first external lateral side provided with said through aperture, in correspondence with said through aperture, so as to determine the at least partial opening of at least a second of said two external lateral sides with respect to said base wall, wherein said washer machine comprises holding means disposed at least in correspondence with the delivery zone of the washing liquid by said delivery nozzles, and able to hold at least said first external lateral side in the first folded position, so that the thrust action of the washing liquid is concentrated on said second external lateral side.

2. (canceled)

3. The plant as in claim 1, wherein said holding means comprises at least a first shaped tubular element disposed along the direction of feed of said containers, and having a first segment disposed in correspondence with said first external lateral side, to prevent said first external lateral side rotating, and a second segment disposed outside the bulk of said first external lateral side, freeing the possible rotation thereof.

4. The plant as in claim 1, wherein said holding means comprises at least a second tubular element able to keep at least said second external lateral side in the second open position.

5. The plant as in claim 1, wherein said holding means comprises at least a third tubular element able to cooperate with said external lateral sides in order to effect and promote the folding thereof at the end of washing.

6. The plant as in claim 1, also comprising a command and control unit installed on board said washer machine, and able to selectively manage the delivery of said washing liquid through one or the other of said delivery nozzles, so as to define a determinate opening sequence of said sides with respect to said base wall.

7. The plant as in claim 6, wherein said command and control unit also allows to manage the specific pressure of delivery of each of said delivery nozzles, or of predefined groups of said delivery nozzles.

8. The plant as in claim 1, wherein said delivery nozzles are selectively rotatable around respective longitudinal and transverse axes, in order to define respective delivery arcs of said washing liquid.

9. The plant as in claim 1, wherein said washer machine also comprises a translation member opposite said delivery nozzles and provided with a plurality of gripper means able to transport said containers in a suspended condition and facing said delivery nozzles, clamping them by a lateral edge of their base wall.

10. The plant as in claim 9, wherein said translation member comprises two chains disposed substantially parallel with each other and longitudinally inside said washer machine, and able to support and cyclically move a plurality of said gripper means.

11. The plant as in claim 9, wherein each of said gripper means comprises a frame defining at least an abutment wall for a first edge of said container, and with which frame a mobile wall is slidingly associated, on the side opposite said abutment wall, for a second edge of said container, said mobile wall being selectively movable between a first operating condition of clamping and a second operating condition of release of said container, by means of a cam mechanism.

12. The plant as in claim 11, wherein said mobile wall is associated with an elastic thrust element mounted on said frame, and able to normally exert a pressure on said mobile wall to maintain it said mobile wall in said first condition of clamping.

13. The plant as in claim 11, wherein said abutment wall and/or said mobile wall comprise respective knurled and/or indented surfaces, to increase the grip on the respective edges of said container.

14. A method for washing containers of food and/or medical and pharmaceutical products, in which said containers comprise at least a base wall and a plurality of lateral sides hinged to said base wall in order to define at least a first folded condition, in which said sides are folded in overlapping pairs and substantially parallel to said base wall, with two lateral sides disposed external and two lateral sides disposed internal and adjacent to the base wall, and a second open condition, in which said sides are substantially perpendicular to said base wall and define a containing compartment of said container, at least a first of said external lateral sides having at least a through aperture, comprising at least a first step in which said containers are fed into a washer machine in said first folded condition, and a second step in which at least a second of said two external lateral sides is at least partially opened with respect to said base wall, by means of a washing liquid delivered under pressure by a plurality of delivery nozzles of said washer machine, said delivery nozzles being directed so as to direct said washing liquid mainly towards said first external lateral side provided with said through aperture, in correspondence with said through aperture, wherein in said second step, by means of holding means of the washer machine which are disposed at least in correspondence with the delivery zone of the washing liquid by said delivery nozzles, said first external lateral side is hold at least in the first folded position, so that the thrust action of the washing liquid is concentrated on said second external lateral side.
